(19) United States
(12) Patent Application Publication
(10) Pub. No.: US 2022/0309048 A1
(43) Pub. Date: Sep. 29, 2022

(54) METHOD FOR STORING DATA TO AND RETRIEVING DATA FROM AT LEAST ONE DATA STORAGE, SYSTEM, USE, COMPUTER PROGRAM, AND COMPUTER READABLE MEDIUM

(71) Applicants: Nathan ANDRYSCO, Round Rock, TX (US); SIEMENS INDUSTRY SOFTWARE NV, Zaventem (BE)

(72) Inventor: Nathan Andrysco, Round Rock, TX (US)

(21) Appl. No.: 17/635,732

(22) PCT Filed: Aug. 21, 2019
(86) PCT No.: PCT/US2019/047414

§ 371 Date: Feb. 16, 2022

(51) Int. Cl. G06F 16/22; G06F 16/21

(52) U.S. Cl. CPC G06F 16/22; G06F 16/21

(57) ABSTRACT

A method is provided for storing data to and retrieving data from at least one data storage. The method includes receiving data to be stored, selecting only part of the received data to obtain reduced data, storing the reduced data on the at least one data storage, receiving a request for retrieval of the data, using at least one compressive sensing reconstruction algorithm to generate reconstructed data from the reduced data, and providing the reconstructed data as the requested data. The disclosure furthermore relates to a system for storing and retrieving data, the use of the compressive sensing technique, a computer program, and a computer readable medium.

The present patent document is a § 371 nationalization of PCT Application Serial No. PCT/US2019/047414, filed Aug. 21, 2019, designating the United States, which is hereby incorporated by reference.

### TECHNICAL FIELD

The disclosure relates to a method for storing data to and retrieving data from at least one data storage. The disclosure furthermore relates to a system for storing and retrieving data, the use of the compressive sensing technique, a computer program, and a computer readable medium.

### BACKGROUND

Software simulations of physical phenomena, for example, are increasingly becoming more complex as the computational powers of the available machines become increasingly better. More complex simulations also require more available storage so that the results of these simulations may be saved and then analyzed.

For state-of-the-art simulations, this storage requirement may be on the order of terabytes. Even for much smaller simulations, gigabyte sized save states is not uncommon.

Data storage, (for example, simulation data storage), may be reduced by using various formats. For example, “zip” formats (e.g., .zip, .gzip, .rar, etc.) may be used. These formats are lossless.

If some error may be tolerated, lossy compression algorithms (for example, .jpeg) may also be applied. Exact data may not necessarily be needed for many simulation post-processing applications. Therefore, lossy storage is an option to save data storage space. A widely used form of lossy compression is the so-called discrete cosine transform (DCS). It is used for image compression formats, such as JPEG, video coding standards, such as MPEG and audio compression formats, such as MP3.

From the documents, Jiaxing Zhang et al., “Impression Store: Compressive Sensing-based Storage for Big Data Analytics,” Usenix, The Advanced Computing Systems Association, 2014, pp. 1-6, and from M Tanooj Kumar et al., “Cloud Storage Optimization Approach Using Compressive Sensing,” 2018, pp. 21-26, compression and reconstruction of data via compressive sensing is known.

### SUMMARY AND DESCRIPTION

It is an object of the present disclosure to provide an alternative method which enables efficient compression of data storage, and which may be carried out with comparably little effort. It is a further object of the present disclosure to provide a system for carrying out such a method.

The scope of the present disclosure is defined solely by the appended claims and is not affected to any degree by the statements within this summary. The present embodiments may obviate one or more of the drawbacks or limitations in the related art.

The first object is solved by a method for storing data to and retrieving data from at least one data storage. The method includes receiving data to be stored, selecting only part of the received data to obtain reduced data, storing the reduced data on the at least one data storage, receiving a request for retrieval of the data, using at least one compressive sensing reconstruction algorithm to generate reconstructed data from the reduced data, and providing the reconstructed data as the requested data.

The second object is solved by a system for storing and retrieving data. The system includes at least one receiving module being embodied and/or configured for receiving data to be stored, at least one reducing module being embodied and/or configured for obtaining reduced data by selecting only part of received data being and/or having been received by the receiving module, at least one data storage being embodied and/or configured for storing reduced data being and/or having been reduced by the reducing module, and at least one reconstruction module being embodied and/or configured for generating reconstructed data from reduced data saved on the data storage by use of at least one compressive sensing reconstruction algorithm.

The present disclosure provides a novel lossy compression scheme that may be applied to help combat the ever-growing storage problem. The disclosure proposes the use of compressive sensing as a storage solution. According to the disclosure, compressive sensing is used as a data compression algorithm/method.

The comparably new technique of compressive sensing (also called compressed sensing, compressive sampling, sparse sampling) is known from the field of signal detection. The basic idea of compressive sensing is that the sparsity of a signal that has to be measured may be exploited to reconstruct the full signal but needing only a few measured samples instead of the much higher sampling rate of traditional Nyquist-Shannon sample theory (where this theory assumes the signal is dense). In practice, most signals across all domains are sparse and compressive sensing may be applied.

According to the present disclosure, compressive sensing is transferred to the field of data storage, in particular, applied to obtain a reduction in data storage space. While compressive sensing so far has only been used as a method of reducing the number of measurement points needed when trying to reconstruct some real-life signal, the present disclosure is kind of a reverse of that. It starts from having the full signal/full data (received data), for example, an entire image or entire simulation data, and creates a selection from the full data to reduce the amount of information that needs to be stored on a data storage, for example one (or more) disk(s).

The received (full) data that needs to be stored may include or is composed by a number of elements, in particular values/numbers. In case of an image for example, the data includes—as known from the state of the art—a number of pixels arranged in columns and rows like a 2D grid or matrix. Each pixel may be represented by one or more values/numbers, for example, RGB-value(s). A set of data that is outputted from a computational simulation may include or be composed by a number of values/numbers representing any physical quantity/quantities.

That only part of the data to be stored is selected may mean or include that only some of the elements of the data to be stored are selected while others are not selected but discarded.

The selection may be such that from all the elements of the data to be stored (received data), some elements are randomly selected.

A part of the received data may be selected by sampling the data. Then a sampling, in particular, a sparse sampling is created/obtained from the received (full) data.

In the context of the present application, “sparse” in particular means that the number of elements/values that are not selected but discarded is more than the number of the selected elements/values that are being stored. Accordingly, if the received data includes 100 elements, a sparse sampling would be obtained if a maximum number of 49 elements would be selected and at least 51 elements be discarded. The selection, in particular, sampling within the framework of the present disclosure, may be such that a sparse selection/sampling is obtained but this is not necessary. In theory, even if all but one element of received data would be selected/sampled and stored, a compressive sensing reconstruction algorithm may be used to obtain reconstructed data from this “reduced” data.

The received data that has to be stored may have a structure. The received data may include a number of elements in a grid, for example, a 2D grid.

Information about the size of the received data may be stored together with the reduced data, in particular, together with selected elements. The information about the size of the received data may be received before or together with the received data. Of course, it is also possible that the size of the data is determined.

Alternatively, or in addition, information about the locations/positions of the selected elements within the received (full) data, in particular, within the received (full) data's structure is stored together with the selected elements.

If the received data is a grid, for example, a 2D or 3D grid including a number of elements, in particular values, the grid size may be stored together with the selected elements. A grid size may be 10×10 or 100×100 or 1000×1000, in case of a 2D grid, or 10×10×10 or 100×100×100 or 1000×1000×1000, in case of a 3D grid as known from the state of the art.

As regards the selected elements' positions, one possibility would be that together with each selected element, (in particular, value), coordinates of the respective element within the data (structure) are stored.

The selected elements together with information about their locations/positions in the original, received data may be stored in a sparse matrix format.

From the state of the art several sparse matrix formats are known (see for example https://en.wikipedia.org/wiki/Sparse_matrix). A sparse matrix format may include the values of a sparse matrix that are not zero and information about their positions within the matrix.

Within the framework of the present disclosure, the selected data together with information about the positions of the elements may be stored in any known sparse matrix format.

One example would be the so-called Coordinate list or COO format which stores a list of (e.g., row, column, value) tuples for a matrix. It has shown that this format is especially suitable in case of randomly selected elements.

The use of a sparse matrix format has shown particularly useful when less than 25% of the values are non-zero. Accordingly, a sparse matrix format may be used as a storage format for the selected data if 25% or less of the received (full) data is selected.

According to another embodiment, it is determined, in particular calculated, which data storage format requires the least amount of data space, and that format is used for storing the selected data in particular together with information of the positions of selected elements.

According to an embodiment, part of the received data is selected by randomly sampling the received (full) data. If the received data is for example at least one image, a random sampling of pixels or values/numbers representing the pixels may be performed to obtain the reduced data.

One possible way to randomly select, in particular, randomly sample would be to use a random number generator to pick random elements, in particular values of the received data. Any modern programming language's (for example, C++, Java, Python, etc.) random number generation functionality may be used for this purpose. If there were for example 100 values in a matrix, and only 10%, (e.g., 10 values shall be randomly picked/selected), one may call a programming language's random function 10 times asking it for an integer in the range [1, 100]. There is a chance that one may get a repeated value (e.g., the first time one asks for a value one may get 37 and then on the 9th time one may also get a value of 37), so some care might need to be taken. For certain languages, there already is a sophisticated enough mechanism implemented that you are guaranteed to get unique numbers.

For the most part, there is no such thing as truly random numbers in software. The random number generators, as available as part of most programming languages, may start with a user specified seed value (e.g., some integer). When a random number is requested, this seed value is transformed (e.g., via multiplication, addition, and modulo) into another integer value. This value will then be divided by the maximum possible integer value allowed by random number generator, providing a value between (0, 1). When another number is requested, this previous integer value is again translated to another integer, providing another value to the user. These values are considered pseudo-random because they really are just a fixed sequence of integers. But the underlying algorithm used to generate this sequence makes the values seem random. There are measures of this “randomness” for each generator type. In practice, a current system time may be used as the initial seed value so that one would get a different value sequence each time the random number generator is run.

Within the context of the present application, pseudo-random numbers being generated with known software mechanisms are considered as random. Accordingly, a selection, in particular, sampling that is performed with the use of pseudo-random numbers is considered a random selection, in particular random sampling.

There are also some hardware mechanisms available that actually generate random numbers by observing the chaotic nature of atomic scale events. Something like this might be available in modern CPUs and a language like C++ might have a library available where the user may use these mechanisms. But the software pseudo-random values are more than sufficient within the framework of the present disclosure so such hardware mechanisms may be used but are not required.

The selection/sampling may be performed with a sampling rate that is lower than the sampling rate according to Nyquist Shannon sampling theory.

Due to selecting only part of the data and discarding the rest, in particular, due to sampling, the reduced data is obtained. The reduced data may include a number of elements, for example values, which is lower (reduced) as compared to the number of elements of the received (full) data.

When the “full” signal is wanted again, at least one compressive sensing reconstruction algorithm is applied to the reduced data, in particular, the sparse samples. A compressive sensing reconstruction algorithm in other words is a reconstruction algorithm intended for reconstruction in the context of compressive sensing/known from the field of compressive sensing for signal reconstruction.

Within the framework of the reconstruction, it is possible that the elements/values that have not been selected but discarded are represented as zeroes. It is also possible that there is for example just a list of the selected elements/values and their corresponding locations in the data, for example grid.

When the reduced data includes a number of elements that is lower than the number of elements of the received (full) data, the number will rise again due to reconstruction. This is in complete analogy to conventional compressive sensing where a comparably small number of measurements, in particular, less than necessary according to the Nyquist Shannon sampling-theorem, are taken and by reconstruction, more samples of the signal are obtained.

The present disclosure offers the big advantage of helping to strongly reduce necessary storage space.

One embodiment is characterized in that a user specifies how much of the received data is selected. As regards the amount/proportion/percentage of the data that is selected, the expression sparsity or sparsity value may be used. A user may accordingly select a sparsity/sparsity value and by that define how strongly the data is compressed or reduced before saving. A user may pick any rate of reduction to reduce the storage requirement by that sparsity amount.

A sparsity value of 5%, for example, may represent only selecting 5% of the total elements, in particular, values to store. From a received (full) data with a size of 1 GB, only 50 MB would be selected which means that while for example previously 1 GB had to be stored, now only 50 MB will be stored. A chosen sparsity value of 10% would mean that from for example 1 GB only 100 MB will be selected/sampled and stored.

How much of the (full) received data will be selected, (in particular, sampled), may be chosen for example by a user on a case-to-case basis. The amount may also be predefined, for example, in a system which is used for performing the acts of the method.

When selecting a sparsity value, it may be at a tradeoff of accuracy. The denser the selection/sampling of the data to be stored, e.g., the denser the reduced data, the better the reconstruction, and more closely the reconstructed result will match the ground truth. Nevertheless, when using compressive sensing, the reconstruction algorithm may enable a surprisingly accurate result with, for example, as little as 1% sampling needed. Accordingly, a very high reduction rate in storage space may be achieved with the present disclosure while at the same time data of sufficient good quality may be provided on demand from the reduced, saved part of the data.

According to an embodiment, less than 20%, less than 10%, or less than 5% of the received data is selected to obtain the reduced data. In these cases, reduced data in an amount of less than 20%, less than 10%, or less than 5% of the received data is obtained. It has been shown that these values enable a very high storage saving rate and at the same time deliver good results as regards the reconstructed data.

The reconstruction may be applied/performed automatically, for example, in reaction to receiving a request for retrieval of stored data. In this case, no manual intervention of a user is necessary. The user will not notice any difference to a conventional data storage procedure known from the state of the art—expect for maybe some time delay because of the reconstruction.

Another embodiment is characterized in that the data is in addition being compressed by use of at least one lossy compression method and/or at least one lossless compression method after it has been received and before part of it has been selected and/or after part of it has been selected and before it is stored.

In this embodiment, the compressive sensing approach for data storage is not a replacement for conventional lossy and/or lossless compression schemes known from the state of the art but is additive to the very large library of available storage schemes. It has shown that such a combination is particularly advantageous.

In case at least one conventional lossy and/or lossless compression method is additionally applied, at least one corresponding inverse compression method may be applied after the request for retrieval of data.

The at least one corresponding inverse compression (in particular, decompression) method may be applied before or after the at least one compressive sensing reconstruction algorithm is used.

A conventional method/technique that may be used in addition may be the so-called discrete cosine transform (DCS) or at least one method/technique based thereon. For reversing the conventional compression, corresponding inverse methods may be used as is known from the state of the art.

Especially if images or videos are to be stored, the disclosed approach may be applied together with JPEG or MPEG compression. A combination of the disclosed approach and conventional compression may be used to reduce image/movie storage because the various image storage schemes (for example, MPEG) are just a conglomeration of various compression techniques.

The one more of the conventional lossy and/or lossless compression methods may be applied for example after the part of the data has been selected and the reduced data was obtained, in particular after a sparse number of samples (reduced data) has been recorded/stored. The traditional data compression may then be applied on top.

It is also possible that one or more conventional lossy and/or lossless compression techniques are applied before the part of the data is selected, in particular applied to the data before the act of reduction takes place. In this case, the conventional compression is applied to the received data.

It is also possible that one or more conventional lossy and/or lossless compression methods is applied to the data before the selection, e.g., to the received data, and that one or more conventional lossy and/or lossless compression methods are applied to the data after the selection, e.g., to the reduced data.

For example, a jpeg compression may first be applied in case the received data is an image. After the jpeg-compression, there will still be an image (2D matrix) of (DCS) values. Random values from this image/2D matrix may then be picked and eventually reconstructed to provide the full DCS matrix (and then inverse DCS may be applied to get the original image).

A lossless compression scheme, like Huffman coding, may also be used for compression, in particular, compressing a 2D matrix. Again, the result is still a 2D matrix where random samples may be taken and then eventually reconstructed (and then the Huffman coding applied to get the original matrix).

One example of combining compressive sensing with other algorithms in reverse order would be that random samples are taken for example from a 2D matrix (received data), and from those values, a Huffman code may be used to further reduce the storage. To reconstruct, the Huffman code is interrupted and expands to the random sample values, which then are used to reconstruct the 2D matrix.

As regards the reconstruction algorithm, any reconstruction algorithm(s) that is (are) suited/used/developed for the field of compressive sensing, in particular signal-reconstruction in the field of compressive sensing, may be used for the reconstruction within the framework of the present disclosure, in particular for reconstruction starting from the saved, reduced data.

Suitable examples are reconstruction algorithms (or equations, the two expressions are used synonymously) according to the so called L₁-optimization and/or according to the so-called greedy approach.

Therefore, a further embodiment is characterized in that the reconstructed data is obtained from the reduced data by use of at least one reconstruction algorithm/equation according to L₁-optimization.

Alternatively, or in addition, the reconstructed data may be obtained from the reduced data by use of at least one reconstruction algorithm/equation according to a greedy approach.

Further reconstruction algorithms/equations from the field of compressive sensing that may alternatively or in addition be used for reconstruction within the framework of the present disclosure are algorithms/equations according to the so-called convex optimization approach and/or the thresholding approach and/or the combinatorial approach and/or the non-convex approach and/or the Bayesian approach. These approaches are, for example, described in the paper “A Systematic Review of Compressive Sensing: Concepts, Implementations and Applications” by M. Rani, S. B. Dhok and R. B. Deshmukh, IEEE Access, Vol. 6, pp. 4875-4894, January 2018 which gives an overview of compressive sensing including an overview of different reconstruction approaches. To give one example, algorithms/equations (1) to (4) disclosed on pages 4876 and 4877 of this paper may be used as reconstruction algorithms for the approach.

Reconstruction algorithms according to any one of the aforementioned approaches, in other words algorithms that are based on any one of the aforementioned approaches have proven useful in the field of compressive sensing and may also be used for the reconstruction within the framework of the present disclosure, e.g., for a reconstruction starting from the saved, reduced data.

The basics of compressive sensing and in particular the sparse reconstruction using the L₁-approach and the greedy approach are for example also described in the paper “A User's Guide to Compressed Sensing for Communications Systems” by K. Hayashi, M. Nagahara, and T. Tanaka, IEICE Trans. Commun., Vol. E96-B, No. 3, March 2013. The reconstruction algorithms/equations disclosed therein may also be used for obtaining the reconstructed data from the reduced data, for example, equations (23) to (31) disclosed on page 688 of this paper might be used in this context. In this publication the papers “Compressed sensing” by D. L. Donoho, IEEE Trans. Inf. Theory vol. 52, no. 4, pp. 1289-1306, April 2006 and “Decoding by linear programming” by E. J. Candes and T. Tao, IEEE Trans. Inf. Theory vol. 51, no. 12, pp. 4203-4215, December 2005 and “Robust uncertainty principles: Exact signal reconstruction from highly incomplete frequency information”, IEEE Trans. Inf. Theory, vol. 52, no., pp. 489-509, February 2006 are cited inter alia, which also disclose suitable compressive sensing reconstruction algorithms.

The paper “DR²-Net: Deep Residual Reconstruction Network for Image Compressive Sensing” from H. Yao, F. Dai, D. Zhang, Y. Ma, S. Zhang, Y. Zhang, and Q. Tian, dated Nov. 16, 2017, discloses deep learning-based reconstruction algorithms for compressive sensing. This rather new reconstruction technique uses neural networks. One or more of the reconstruction algorithms/equations disclosed in this newer paper may also be used to obtain the reconstructed data from the reduced data within the framework of the present disclosure.

A further publication regarding compressive sensing is the paper “Sparse representation for wireless communications: A compressive sensing approach” by Z. Qin, Y. Liu, Y. Gao, and G. Y Li, IEEE Signal Processing Magazine 35.3 (2018): 40-58. The reconstruction algorithms disclosed therein are further examples of algorithms that may be used to obtain the reconstructed data from the reduced data.

The same holds for the paper “Compressive Sensing Techniques for Next-Generation Wireless Communications” by Z. Gao, L. Dai, S. Han, C.-L. I, Z. Wang, and L. Hanzo, IEEE Wireless Communications 25.3 (2018): 144-153, which also discloses reconstruction algorithm suitable for use in the framework of the present disclosure.

It is possible that the data to be stored is received as a set of data, in particular, as one file, and/or a stream of data. The selection of only a part of the received data may take place after the file/set of data/stream has been fully received.

It is of course also possible that the selection of part of the received data already starts while the receiving process still goes on. Elements, in particular, values may be selected while data streams in. If data is received as a stream, an information of the data size, in particular data dimensions, may be received or determined or provided first and then a number of elements/values may be picked. If for example the information is provided/determined/received that data with dimensions of 5×5 will be streamed, the values at positions [1, 2] and [3, 4] may randomly be picked and only those values would be stored, e.g., together with their positions.

It is also possible that data is streamed after the selection process took place, which means reduced data is streamed, in particular, to the location of the at least one data storage. In this case, data will be received at a first position, a part will be selected and the selected part, in particular, elements will be streamed to a second place, in particular to the place of storage. This may help reduce the bandwidth of the streaming process.

The data that is received and has to be stored may be data that was generated within the framework of computational simulations, in particular computational simulations of physical phenomena. The data that is received and has to be stored may include or be composed by at least one field function.

This is to be understood only exemplary. Data from other sources/other kind of data may of course also be stored in a space-saving way and be reconstructed on demand.

An example of how compressive sensing may be applied for simulation data storage may be given when considering a simulation that records a scalar field across a regular 2D grid (when comparing a 2D-scalar field with an image, each (x, y) position of the scalar field in the 2D grid would be equivalent to an image's pixel position). Instead of storing the full/complete scalar field (e.g., 100% sampling), for example only 5% of the values may be stored on the at least one data storage and the “full/complete” scalar field may be reconstructed when retrieval of/access to the stored simulation data is requested, for example by a user. In the example given, one would have reduced the storage requirement of the scalar field by 95% because only 5% of the values will be stored. Quotation marks are used around “full/complete” because the reconstructed scalar field will of course not be identical, in other words “as full” or “as complete” as the field before the storage procedure. But the quality may and will, as mentioned above, be surprisingly good even if only a small part of the received data is stored which means a high sparsity value is selected.

Grids in higher dimension (for example, 3D grids) or values stored on something more irregular (e.g., values per vertex of an irregular triangle mesh) may also be stored and reconstructed in a similar fashion.

With regard to the system, each of the modules may be a hardware module and/or a software module or a module that includes or is composed of a combination of hardware and software. In case a module is composed of software, it is a purely functional module.

Also, the system may be embodied and/or configured for any one of the features described above or for any combination of these features.

The modules and the at least one data storage of the system may furthermore be arranged at the same place or close to each other. Nevertheless, this is not necessary. It is for example also possible that the receiving module is located at a user's site while the reducing module and the at least one data storage and maybe the reconstruction module is located somewhere else, for example in a data center. The data center and the user site may, as is known from the state of the art, be connected via internet.

The disclosure further relates to the use of the compressive sensing technique for storing data in a space-saving way.

The disclosure also relates to a computer program including instructions which, when the program is executed by at least one computer, cause the at least one computer to carry out the method.

The disclosure furthermore relates to a computer-readable medium including instructions which, when executed on at least one computer, cause the at least one computer to perform the acts of the method.

The computer-readable medium may be, for example, a CD-ROM or DVD or a USB or flash memory. A computer-readable medium should not be understood exclusively as a physical medium, but that such a medium may also exist in the form of a data stream and/or a signal representing a data stream.

### BRIEF DESCRIPTION OF THE DRAWINGS

Further features and advantages of the present disclosure become clear by the following description of embodiments with reference to the enclosed drawings.

FIG. 1 depicts a purely schematic view of an exemplary embodiment of a system.

FIG. 2 depicts acts of an exemplary embodiment of the method.

### DETAILED DESCRIPTION

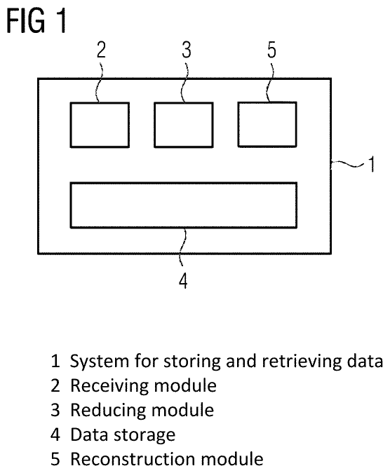

FIG. 1 shows a purely schematic view of a system 1 for storing and retrieving data. The system 1 includes a receiving module 2, a reducing module 3, one data storage 4, and a reconstruction module 5.

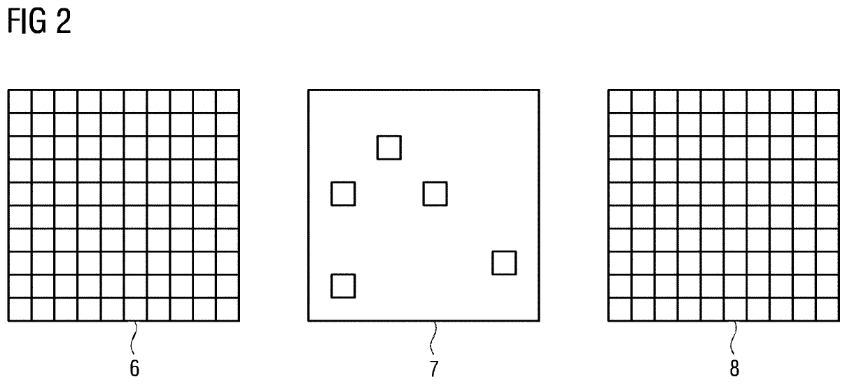

The receiving module 1 is embodied and/or configured for receiving data to be stored (received data 6, see FIG. 2).

The reducing module 3 is embodied and/or configured for obtaining reduced data 7 (see FIG. 2) by selecting only a part of received data 6 being and/or having been received by the receiving module 1. The reducing module 2 is furthermore embodied and/or configured for compressing data with one conventional lossy and/or lossless compression method that is known from the state of the art after part of the data has been selected.

Alternatively, or additionally, the receiving module 2 may be embodied and/or configured for compressing received data 5 with one conventional lossy and/or lossless compression method that is known from the state of the art. Also, alternatively or in addition at least one further module, compression module (not shown) may be disposed, the compression module being embodied and/or configured for compressing received data 6 and/or reduced data 7 with one conventional lossy and/or lossless compression method that is known from the state of the art.

The data storage 4 is embodied and/or configured for storing reduced data 7 being reduced by the reducing module 3. The data storage 4 is a conventional data storage as known from the state of the art, namely a hard disk.

The reconstruction module 5 is embodied and/or configured for generating reconstructed data 8 from reduced data 7 saved on the data storage 4 by use of at least one compressive sensing reconstruction algorithm. In particular, case reducing module 3 (or receiving module 2 or an additional compression module) is embodied and/or configured to apply at least one conventional compression method/technique, reconstruction module 5 may additionally be embodied and/or configured to reverse the at least one conventional compression method/technique before and/or after using at least one compressive sensing reconstruction algorithm.

In the example shown, modules 2, 3, 5 of system 1 are software-implemented, functional modules.

While system 1 is shown in the purely schematic FIG. 1 as a unit, the system's modules 2, 3, 5 and the data storage 4 do not have to be located at the same place or close to each other. The modules 2, 3,5 may be implemented at a user's site, their software may run on a user's PC and the data storage 4 may be a cloud data storage 4 that is accessible via internet. It is also possible that a data storage 4 is used which is located at a user's site while the modules 2, 3, 5 are implemented in a cloud.

With use of the system 1 shown in FIG. 1, an exemplary embodiment of the method for storing data to and retrieving data from at least one data storage 4 may be performed, which uses the compressive sensing approach for the storage and data, and which will now be described in detail.

In an act, data 6 to be stored is received by receiving module 2. In the described example, data 6 from a simulation of physical phenomena is received by receiving module 2. The simulation records a scalar field across a regular 2D grid. The data includes field functions. FIG. 2 shows, in a purely schematic manner, a 2D grid being the received data 6. FIG. 2 shows (for reasons of a simplification) a 10×10 grid. Accordingly, the scalar field has 100 (x, y) positions and includes 100 elements, namely values. In FIG. 2, each of the small boxes represent one of the (x, y) positions of the grid and by that one of the data's elements/values. While a rather small 10×10 grid is exemplary shown in the figures, the grid size of received data 6 in reality may be higher, for example, 100×100 or 1000×1000.

Furthermore, the data to be stored being simulation data is to be understood purely exemplary. Data from other sources and/or other kind of data may of course also have to be stored. For example, data to be stored may also be one or more image files, videos or other kind of data.

From the received data 6, namely the 2D grid outputted from the simulation, the reducing module 3 selects only part to obtain reduced data 7. Module 3 obtains reduced data 7 from the received data 6 in detail by randomly sampling the received data 6, in detail randomly sampling the 2D grid 6. In this way, a sparse sampling of the received data 6 is created and the reduced data 7 is obtained. Module 3 is embodied and/or configured to do so.

In the described example, the sparsity value is selected to be 5%, in particular, by a user. This means only 5% of the received (full) data 6 is selected, namely only 5 values. The size of the reduced data 7 accordingly is only 5% of the size of the received data 6. If for example a scalar field with a size of 100 MB is received, the size of the reduced data 7 is only 5 MB. In the example given, one would have reduced the storage requirement of the scalar field by 95% because only 5% of the values are selected/sampled.

For the random sampling a modern programming language's (for example, C++, Java, Python, etc.) random number generation functionality is used. The reducing module 3 is embodied and/or configured to do so. For the example shown, the programming language's random function is called 5 times asking it for an integer in the range [1, 100]. If the grid size is larger, for example 100×100, the random function would be called 500 times.

In FIG. 2, it is shown (in a purely schematic way) that the reduced data 7 includes only some of the elements/values of the received data 6.

In an additional act, at least one conventional lossy and/or lossless compression method, known from the state of the art, may additionally be applied to the reduced data 7 by reducing module 3 which may be embodied and/or configured accordingly. The additional compression may (in addition or alternatively) be applied before the act of random sampling.

The compressive sensing approach for data storage in this case is not a replacement for (one or more) conventional lossy and/or compression schemes but is additive.

A conventional compression method/technique that may be used in addition may be the so-called discrete cosine transform (DCS) or at least one method/technique based thereon, for example jpeg compression. Alternatively, or in addition the so called Huffmann code may be used as an additional (lossless) conventional compression method.

In case of receiving an image for storage it is for example possible to first apply jpeg compression which would result in another image (full 2D matrix) of (DCS) values. Random values may then be picked from this image/matrix to obtain the reduced data 7.

One example for reverse order would be that first random samples are taken/sampled from the received data 6, and from those values, a Huffman code may be used to further reduce the storage.

After the additional compression (or the random selection/sampling), the obtained reduced data 7 is stored on data storage 4.

Together with the reduced data 7 information about the size of the originally received (full) data 6 is stored.

Also, the reduced data 7 is stored together with information about the locations/positions of the selected elements within the received data's 6 structure. In the example described herein, a sparse matrix format is used for the reduced data 7, namely the so-called Coordinate list or COO format which stores a list of (row, column, value) tuples for a matrix. It has shown that this format is especially suitable in case of randomly selected elements.

As an additional act, a request for retrieval of the stored data is received. Such a request will in the example described herein be received from reconstruction module 5.

In reaction to the request reconstruction module 5 then automatically generates reconstructed data 8 from the stored reduced data 7. To obtain the reconstructed data 8 from the reduced data 7, reconstruction module 5 uses one or more compressive sensing reconstruction algorithms, in other words one or more reconstruction algorithms that are intended for compressive sensing.

In case, for example, DCS compression was used before random sampling, the reverse order may now be applied. In detail, first at least one compressive sensing reconstruction algorithm/equation may be used to obtain a full matrix and then inverse DSC may be applied.

In case Huffmann coding was used as an additional conventional compression after the random selection, for the reconstruction, the Huffman code would be interrupted and expands to the random sample values, which then are used to reconstruct the 2D matrix by use of at least one compressive sensing reconstruction algorithm/equation.

In the present case, reconstruction module 5 uses a compressive sensing reconstruction algorithm that is based on L₁-optimization to generate the reconstructed data 8.

For example, algorithms/equations (23) to (31) disclosed on page 688 of the paper “A User's Guide to Compressed Sensing for Communications Systems” by K. Hayashi, M. Nagahara, and T. Tanaka, IEICE Trans. Commun., Vol. E96-B, No. 3, March 2013 may be used as reconstruction algorithms/equations.

Another example of algorithms/equations that may be used as reconstruction algorithms/equations within the framework of the method are algorithms/equations (1) to (4) disclosed on pages 4876 and 4877 of the paper “A Systematic Review of Compressive Sensing: Concepts, Implementations and Applications” by M. Rani, S. B. Dhok, and R. B. Deshmukh, IEEE Access, Vol. 6, pp. 4875-4894, January 2018. Alternatively or in addition, reconstruction module 5 may obtain the reconstructed data 8 from the reduced data 7 by use of at least one reconstruction algorithm that is based on a greedy approach. Module 5 is accordingly embodied and/or configured. Further reconstruction algorithms/equations from the field of compressive sensing that may alternatively or in addition be used for reconstruction are algorithms/equations according to the so-called convex optimization approach and/or the thresholding approach and/or the combinatorial approach and/or the non-convex approach and/or the Bayesian approach. These approaches are for example also described in the paper “A Systematic Review of Compressive Sensing: Concepts, Implementations and Applications” by M. Rani, S. B. Dhok, and R. B. Deshmukh, IEEE Access, Vol. 6, pp. 4875-4894, January 2018 which gives an overview of compressive sensing including an overview of different reconstruction approaches.

For sake of completeness, while the received data 6 and reconstructed 8 both being a 10×10 2D grid look the same in FIG. 2, they are not identical.

In an additional act, the obtained reconstructed data 8 is provided as the requested data.

Although the disclosure was illustrated and described in more detail by the exemplary embodiments, the disclosure is not restricted by the disclosed examples and other variations may be derived herefrom by the person skilled in the art without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for storing data to and retrieving data from at least one data storage, the method comprising:
receiving data to be stored, wherein the received data is data that was generated within a framework of computational simulations of physical phenomena;
selecting only part of the received data to obtain reduced data;
storing the reduced data on the at least one data storage;
receiving a request for retrieval of the data;
using at least one compressive sensing reconstruction algorithm to generate reconstructed data from the reduced data; and
providing the reconstructed data as the requested data.

2. The method of claim 1, wherein the reduced data is obtained from the received data by sampling the received data.

3. The method of claim 2, wherein the reduced data is obtained from the received data by randomly sampling the received data.

4. The method of claim 1, wherein the reduced data is obtained from the received data by creating a sparse sampling of the received data.

5. The method of claim 1, wherein the received data comprises a plurality of elements, and the reduced data is obtained from the received data by selecting only some elements less than all of the plurality of elements.

6. The method of claim 5, wherein the plurality of elements is a plurality of values.

7. The method of claim 5, wherein information about positions of the selected elements within the received data is stored together with the selected elements.

8. The method of claim 7, wherein a sparse matrix format is used in the storing of the positions of the selected elements with the selected elements.

9. The method of claim 1, wherein less than 20% of the received data is selected to obtain the reduced data.

10. The method of claim 1, wherein a user specifies how much of the received data is selected.

11. The method of claim 1, wherein information about a size of the received data is stored together with the selected data.

12. The method of claim 1, further comprising:
compressing the received data by use of at least one lossy compression method and/or by use of at least one lossless compression method before the part of the received data has been selected and/or after the part of the received data has been selected and before the reduced data is stored.

13. The method of claim 12, wherein at least one corresponding inverse compression method is applied after the request for the retrieval of the data.

14. The method of claim 1, wherein the reconstructed data is obtained from the reduced data by use of at least one reconstruction algorithm according to a L₁-optimization, a greedy approach, a convex optimization approach, a thresholding approach, a combinatorial approach, a Bayesian approach, or a combination thereof.

15. The method of claim 1, wherein a stream of data is received as the data to be stored.

16. The method of claim 15, wherein the stream of data to be stored is received bit after bit and the reduced data is obtained by selecting some of the bits while discarding other bits.

17. (canceled)

18. The method of claim 1, wherein the received data comprises at least one field function.

19. A system for storing and retrieving data, the system comprising:
at least one receiving module configured to receive data to be stored, wherein the received data is data that was generated within a framework of computational simulations of physical phenomena;
at least one reducing module configured to obtain reduced data by selecting only a part of the received data;
at least one data storage configured to store the reduced data; and
at least one reconstruction module configured to generate reconstructed data from the reduced data saved on the data storage by use of at least one compressive sensing reconstruction algorithm.

20. A computer program or computer-readable medium comprising instructions which, when executed by at least one computer, cause the at least one computer to:
receive data to be stored, wherein the received data is data that was generated within a framework of computational simulations of physical phenomena;
select only part of the received data to obtain reduced data;
store the reduced data on at least one data storage;
receive a request for retrieval of the data;
use at least one compressive sensing reconstruction algorithm to generate reconstructed data from the reduced data; and
provide the reconstructed data as the requested data.
